(19) United States
(12) Patent Application Publication
(10) Pub. No.: US 2013/0144696 A1
(43) Pub. Date: Jun. 6, 2013

(54) Methods and Devices for Determining the Price of a Product

(71) Applicant: NETANEL RAISCH, Psagot (IL)

(72) Inventor: NETANEL RAISCH, Psagot (IL)

(21) Appl. No.: 13/308,590

(22) Filed: Dec. 1, 2011

(51) Int. Cl. G06Q 30/02

(52) U.S. Cl. 705/14.16; 705/14.39

(57) ABSTRACT

Methods and systems facilitate electronic commerce by designating an initiator of a sale of an item that is advertised by a merchant at an offering price on an Internet web site. One embodiment comprises detecting performance of designated activities by associates of the initiator via the web site. Responsively to each performance an exclusive offer of the item for sale is made to the initiator at a progressively marked-down price. Another embodiment comprises progressively marking down the advertised price of items upon performance of designated activities by users of the web site and progressively marking up the price upon each purchase of one of the items by the users.

### CROSS-REFERENCE TO RELATED APPLICATIONS

This application claims the benefit of U.S. Provisional Application Nos. 61/423,225, filed 15 Dec. 2010, entitled “Methods and Devices for Allowing a User to Determine the Price of a Product”, and 61/429,222, filed 3 Jan. 2011, entitled “Methods and Devices for Applying a Social Network to the Price of a Product”, which are herein incorporated by reference.

### BACKGROUND OF THE INVENTION

1. Field of the Invention

This invention relates to processing of financial data for price determination. More particularly, this invention relates to on-line activities directed to pricing of products and services.

2. Description of the Related Art

Social networks such as Facebook® and MySpace® have been extraordinary in their growth during the past several years. Facebook alone claims over 500 million unique users, each having tens or hundreds of contacts or “friends”. These arrangements offer unparalleled levels of communication and interaction between individuals and coworkers, friends and friends of friends.

Online shopping has grown exponentially since the early days of internet. Millions of transactions are performed by the hour, with sellers and buyers linked by computer, cell phone or other devices that allow for internet connectivity. Such transactions are done quickly and with a high level of security.

U.S. Patent Application Publication No. 20100088148A1 to Presswla, et al. proposes techniques for optimizing shopping. In one aspect, purchase items are recommended to a user based on the total purchasing costs of the recommended purchase items. In one embodiment, the total purchase cost includes not just the price of the purchase item but also includes weighted costs based on non-price purchasing cost factors. In another aspect, data is maintained that represents social relationships between members of a network of users and purchase recommendations are made to a user based on the relatedness between the user, the item and the other members of the network. In yet another aspect, purchase recommendations are made based on the best time to purchase a purchase item. In another aspect, item retailers can offer purchase item incentives to users based on the identity of and information about the shopper to whom the incentive is offered including bundling incentives in a unified redemption code.

U.S. Pat. No. 7,720,722 to Ho, et al. describes a system that receives, at a network-based social platform, a request from a first user of the network-based social platform. The request is to add an item to a list associated with a second user of the network-based social platform. The list is for watching items offered for sale on a network-based marketplace. Next, the system determines whether the first user is authorized to add the item to the list associated with the second user based on relationship information that identifies a predetermined relationship between the first user and the second user on the network-based social platform. Finally, the system communicates the request to the network-based market-place to add the item to the list associated with the second user.

U.S. Patent Application Publication No. 2009/010685 to Raimbeault describes a social networking interactive shopping system including a portable wireless user interface for use by a store customer when shopping. A merchant server is provided, the server having market survey, advertising, promotions, security, social networking services, web server capability, a quantitative prediction modeling system predicting behavior of the customer, a predictive response marketing/advertising system that targets advertising messages to the customer based on a predicted customer response to the advertising messages, and payment application software. The merchant server is capable of wired or wireless communication with the portable wireless user interface. A database is provided, and can be stored on site or off site. The database includes information associated with items for sale at the store, and is in operable communication with the merchant server. Using the portable wireless user interface, the store customer can purchase user selected store items thereby obviating necessity for travel through a store checkout line.

U.S. Patent Application Publication No. 20100299266 to Catania, et al. describes a system and method for issuance, redemption, and reimbursement of digital incentives. A central database connected to the internet: enables customers to register unique customer registration information; is able to store this information and assign unique identifiers to it; and is accessible to incentives providers to make available digital incentives. Existing point-of-sale terminals: are authenticated to have access to the central database; have payment devices; are connected to the internet; and are provided with a message broker that facilitates communication with the central database. The customer redeems digital incentives at one of the existing point-of-sale terminals at the time of purchase by first presenting their unique identifier. The message broker routes the unique identifier to the central database, which authenticates and validates the existing point-of-sale terminal, the customer's unique identifier, and the payment device. The central database then returns validated applicable digital incentives to the message broker, which forwards the validated digital incentives for redemption.

U.S. Patent Application Publication No. 20090198577 to Foreman et al. proposes an exclusive method, system and model of commerce created between a unique business entity that offers, publishes, and/or distributes any product and/or service through a subscription based membership program purchased by its consumers and the unique business entities' consumers who receive the products and/or services electronically or via mail. The unique business entities' consumers simultaneously operate their own home based business program utilizing a unique viral marketing campaign and cross promotion sales process created by the unique business entity.

### SUMMARY OF THE INVENTION

There is provided according to embodiments of the invention a method of electronic commerce, which is carried out by designating an initiator of a sale of an item that is advertised by a merchant at an offering price on an Internet web site, establishing a designation of a set of activities, wherein performance of said activities may lead to the reduction in price of said item, detecting a performance of one of the activities by at least one of the users of the web site, and identifying the at least one of the users as associates of the initiator in the sale. The method is further carried out responsively to the performance of the activities by making a private offer of the item for sale to the initiator at an adjusted price that is less than the offering price, wherein the offer is capable of acceptance only by the initiator, and wherein at least one of above steps is performed by a computing device.

According to an aspect of the method, the web site is owned by said merchant.

According to another aspect of the method, the set of activities includes a recruitment of new users to perform the set of activities.

According to a further aspect of the method, the set of activities includes at least one of the group consisting of, watching specified advertisements, responding to questions, providing requested information, rating products, accessing the web site, accessing at least one other web site, downloading or uploading specified information, and completing a questionnaire.

According to an additional aspect of the method, there is exactly one initiator.

There is further provided according to embodiments of the invention a method of electronic commerce, which is carried out by advertising an offer for a sale of a plurality of items by a merchant at a current advertised price on an Internet web site, establishing a designation of a set of activities, wherein performance of said activities may lead to the reduction in price of said item, and detecting a performance of one of the activities by the users. The method is further carried out responsively to the performance by marking down the current advertised price and advertising a first revised version of the offer on the web site, and detecting a purchase of one of the items by the users. The method is further carried out responsively to the purchase by marking up the current advertised price and advertising a second revised version of the offer on the web site, wherein at least one of the above steps is performed by a computing device.

According to an additional aspect of the method, the set of activities includes an opt-in activity that expresses an interest in the offer.

According to still another aspect of the method, the set of activities includes a recruitment of new users to perform the set of activities.

According to yet another aspect of the method, the set of activities includes at least one of the group consisting of purchasing at least one of the items, watching specified advertisements, responding to questions, providing requested information, rating products, accessing at least one other web site, downloading or uploading specified information, and completing a questionnaire.

According to one aspect of the method, the set of activities also includes an opt-in activity that expresses an interest in the offer performed by an opt-in set of the users, respectively, and the purchase also includes respective purchases of the items by a purchasing set of the users, and wherein marking up and marking down the current advertised price are iteratively performed responsively to the purchases as a function of a number of members of the opt-in set and a number of members of the purchasing set.

According to another aspect of the method, wherein a current price of said items is passed along to the users by SMS or email

According to one aspect of the method, marking down the current advertised price is performed responsively to an addition of a new member to the opt-in set and marking up the current advertised price is performed responsively to an addition of a new member to the purchasing set.

According to a further aspect of the method, establishing a designation of the set of activities includes providing a set of price-reducing activities to be performed by any of the users and advertising an offer includes providing a description of the set of price-reducing activities.

Yet another aspect of the method includes detecting an occurrence of a termination condition, the termination condition including an adjustment of the current advertised price below a predetermined value, and withdrawing the offer responsively to detecting the occurrence of the termination condition.

Other embodiments of the invention provide computer software products for carrying out the above-described methods.

### BRIEF DESCRIPTION OF THE SEVERAL VIEWS OF THE DRAWINGS

For a better understanding of the present invention, reference is made to the detailed description of the invention, by way of example, which is to be read in conjunction with the following drawings, wherein like elements are given like reference numerals or reference numerals advanced by the appropriate multiple of 100, and wherein:

FIG. 1 is a schematic representation of an arrangement for executing a sale according to an embodiment of the present invention;

FIG. 2 is a schematic representation of an example of a private sale executed in accordance with an embodiment of the invention;

FIG. 3 is a schematic representation of an arrangement for executing a sale in accordance with an alternate embodiment of the present invention;

FIG. 4 is a schematic representation of an example of a sale executed by the embodiment shown in FIG. 3;

FIG. 5 is a schematic representation of an arrangement for executing a sale in accordance with an alternate embodiment of the present invention;

FIG. 6 is a flowchart of a method of executing a sale in accordance with an embodiment of the invention;

FIG. 7 is a flowchart of method of executing a sale in accordance with an alternate embodiment of the invention;

FIGS. 8-10 are examples in tabular format related to the method shown in FIG. 7;

FIG. 11 is a high level diagram of a sales management system, which is constructed and operative in accordance with an embodiment of the invention; and

FIG. 12 is a block diagram showing aspects of a computing device which is programmed for operation in accordance with embodiments of the invention.

### DETAILED DESCRIPTION OF THE INVENTION

In the following description, numerous specific details are set forth in order to provide a thorough understanding of the various principles of the present invention. It will be apparent to one skilled in the art, however, that not all these details are necessarily always needed for practicing the present invention. In this instance, well-known circuits, control logic, and the details of computer program instructions for conventional algorithms and processes have not been shown in detail in order not to obscure the general concepts unnecessarily.

Aspects of the present invention may be embodied in software programming code, which is typically maintained in permanent storage, such as a computer readable medium. In a client/server environment, such software programming code may be stored on a client or a server. The software programming code may be embodied on any of a variety of known non-transitory storage media for use with a data processing system, such as a diskette, hard drive, electronic media or CD-ROM. The code may be distributed on such media, or may be distributed to users from the memory or storage of one computer system over a network of some type to storage devices on other computer systems for use by users of such other systems.

### DEFINITIONS

A product suitable for commerce according to the embodiments herein may be anything that can be sold or bartered, including but not limited to tangible and intangible property and services, e.g., food, cosmetics, cars, travel, tickets, consumer products, electronics, computer, music players, tablet computers, clothes, furnishings, shoes, music, books, appliances, homes, real estate, stocks, bonds, antiques, valuables, jewelry, vacations, transportation, perfume, animals, and personal items.

### Embodiment 1

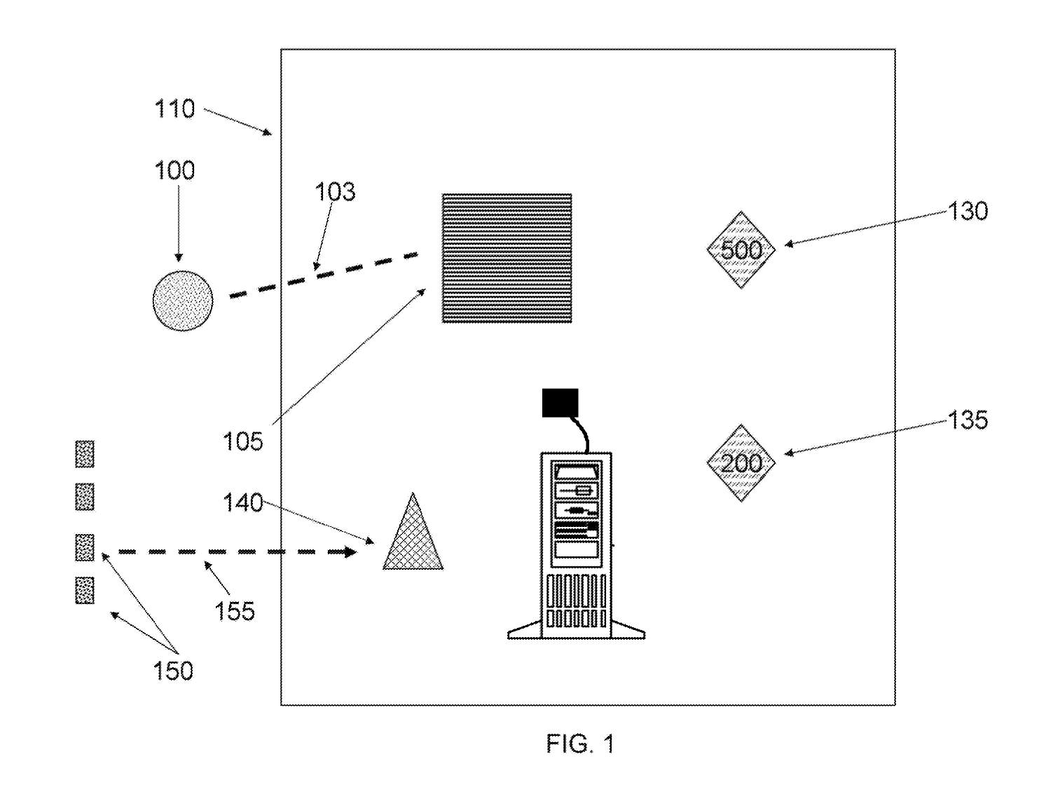

Attention is turned to FIG. 1, which shows a schematic view of an embodiment of the present invention. This embodiment concerns a on-line marketing arrangement, referred to herein for convenience as a “private sale”. The arrangement involves the cooperation of a merchant, the initiator of the sale, and associates of the initiator. An initiator 100 of the private sale, who is typically an Internet user or a member of a social network, arranges with an Internet merchant to sell or purchase an item in a manner that is explained below. Initiator 100 identifies 103 a product 105 on a web site 110 controlled by a server 111 connected to the Internet, which is programmed with suitable software for carrying out the functions described hereinbelow. Events in the following discussion are sometimes referred to herein for convenience as being perceived or carried out by the web site 110. It will be understood that actions and changes in the state of the web site 110 are actually mediated by the server 111.

The initiator 100 wishes to acquire the product 105. The product 105 has an associated advertised price 130, which is dictated by the web site 110. The initiator 100 can notify the web site 110 that he wishes to initiate a private sale wherein the initiator 100 may be the only person who can purchase the product 105 at an exclusive less-than-advertised price. The web site 110 sets up a private sale of the product 105 or a group of products (not shown) for the initiator 100. The web site 110 provides instructions to the initiator 100 as to how he can reduce the advertised price 130 of the product 105 by recruiting participants to engage in activities considered to benefit the merchant. Instructions may include a set of activities such as watching an advertisement 140, the advertisement optionally being related to the product 105 or the company that manufactures the product 105, filling out a questionnaire, performing an activity, following a link to another web site, or providing some information (not shown). Initiator 100 typically recruits participants by contacting friends, acquaintances, or others 150 either directly or through the web site 110 and request from the friends, acquaintances, or others 150 their help in reducing the price 130 to the initiator of the product 105. Friends, acquaintances, or others 150 can, for example, watch 155 an advertisement 140, with each view of the advertisement 140 directly lowering the price 130 of the product 105 to the initiator.

Each qualified activity is detected by the web site 110, which responds by reducing the price of the product 105 to the initiator 100 by a predetermined and optionally advertised amount. The web site 110 may verify that a real person has viewed the commercial and may limit the number of times a unique individual can view the commercial 140. Any conventional security arrangement may be employed to assure the merchant that the activities are being performed by associates of the initiator 100 and not by others or by automatons. For example the associates may be sent codes, such as one-time or n-time passwords. These may be conveniently accomplished by Short Message Service (SMS) transmissions to cellular telephones or other mobile information devices of the associates. Many variants of such authentication schemes will occur to those skilled in the art. Friends, acquaintances, or others 150 may be provided a plurality of activities such as answering questions or watching 155 an online commercial 140, and recruiting new participants to perform the activities, each performance of an activity causing the web site 110 to further reduce the price of the product 105. After a predetermined period of time, or when product 105 dynamic price 135 reaches zero (or another predetermined floor) or when initiator 100 decides to buy, product 105 is purchased by initiator 100 from the web site 110 or a related site (not shown). The “dynamic price” is the actual price of the product, it being the advertised price 130 less any markdowns resulting from the activities of the initiator 100 and his friends, acquaintances or others 150 as described above.

It may be noted that while no direct financial benefit accrues to the associates of the initiator 100 as a result of their participation in a particular private sale, the associates nevertheless may be induced to cooperate with the initiator 100 in the knowledge that they themselves could become initiators of such private sales in the future and expect cooperation in return from their own associates.

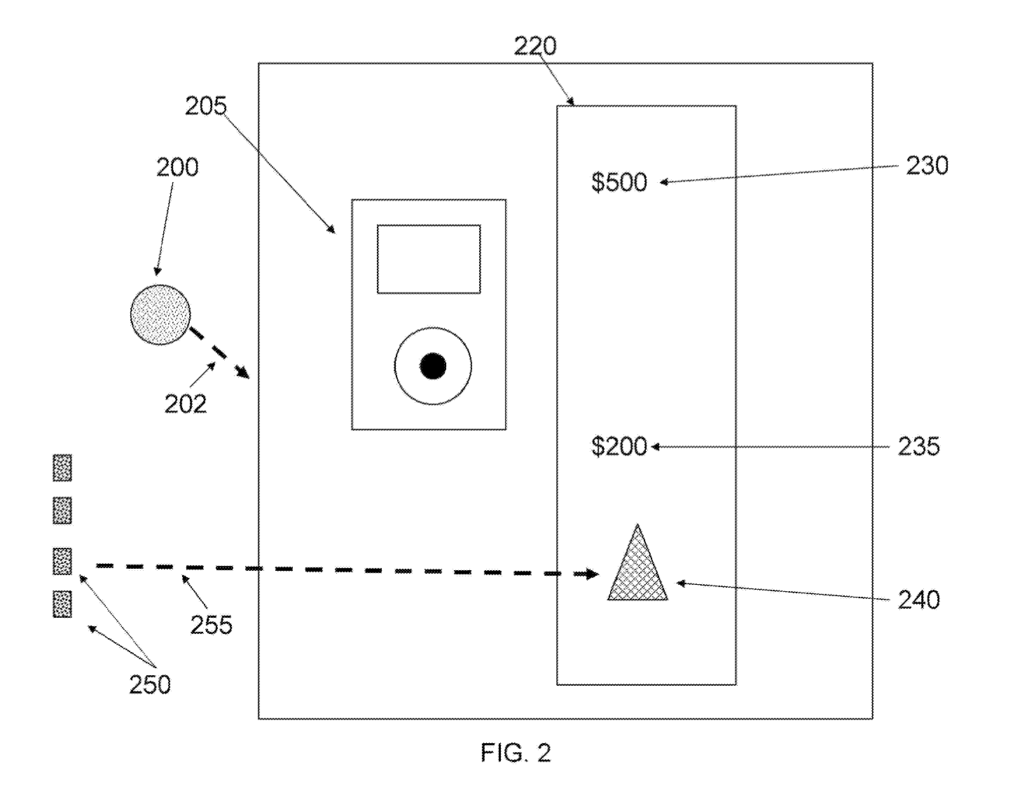

Attention is now directed to FIG. 2, which is a diagram that offers an example of the first embodiment in practice. A music player 205 is for sale for an advertised price 230 of $500. An initiator 200, operating a computer, cell phone or other communications device, informs 202 the web site 210 selling the music player 205 that she wishes to enter a private sale. Web site 210 sets the music player 205 into an optional private sale window 220 and instructs initiator 200 that for every viewing of a video advertisement 240 from the manufacturer of the music player 205, the web site 210 will reduce the price of the music player 205 by 50 cents. Each unique visitor to the web site may watch the video up to a predetermined number of times, typically four times during the private sale; thus each unique visitor to the private sale (which may be advertised by the web site 210 but will most generally be advertised by the initiator 200) may reduce the price of the music player 205 by a maximum of $2. The web site 210 agrees to this arrangement as each viewing of the video advertisement 240 means that it is paid $1 by the manufacturer of the music player 205, for example. The initiator 200 recruits associates by contacting friends, relatives, and coworkers via a social network web site, email, SMS, instant messaging and other means in order to encourage them watch 255 the video advertisement 240 at no cost to them but in the process reduce the advertised price 230 of the music player 205. In total, 600 views of the video advertisement 240 are performed by friends, acquaintances or other associates 250 and the price of the music player 205 is reduced to a dynamic price 235 of $200. In some embodiments the associates may be limited to individuals known to the initiator or personally designated by the initiator. In other embodiments the associates may include members of an organization or class to which the initiator belongs, e.g., subscribers to the web site 210, irrespective of the initiator's personal acquaintanceship. The initiator 200 purchases the music player 205 for $200. The web site 210 receives the $200 from initiator 200 as well as $600 from the manufacturer of the music player 205, for a gross of $800 for the private sale. A regular online sale of music player 205 would have grossed $500, the advertised price 230 of the music player 205.

In the end, the web site 210 owners are better off as they made more money than they could have through a standard sale. Initiator 200 is better off as she purchased the music player 205 for less than half of its advertised price 230. The manufacturer of the music player 205 is better off as it received 600 confirmed views of its commercial, all from friends and associates of initiator 200, who expressed interest in products from the manufacturer. And finally, the friends and acquaintances 250 of initiator 200 are better off for having helped her acquire the product of her dreams at such a reduced dynamic price 235. A window (not shown) on user's 200 computer display, cell phone or other device could give realtime information on the private sale such as the dynamic price 235 of product 205.

A private sale as herewith described may be performed on any platform that has connectivity to the internet: computers, cell phones, tablet computers, etc. A private sale could also be performed by a “brick and mortar” store or the like, wherein sale of a product or a group of products is limited to a single customer or a small group.

In any of the embodiments herein, activities that could be asked of individuals in order to bring down the price of a product or service according to any of the embodiments herein may include but are no way limited to watching specified advertisements, responding to questions, providing requested information, rating products, going to one or a plurality of web sites, performing activities on one or a plurality of web sites, downloading or uploading information, filling out questionnaires, or doing a combination of different activities as specified by the web site. The web site may verify completion of one or a plurality of activities by any means, and the web site 110 can use appropriate security measures to guarantee that those who opt-in and those who perform activities related to reducing the cost of the product or service are real people and not just computers acting as users or members. Such measures might include password protection or entry of a code sent by SMS to a cell phone of user, for example.

### Embodiment 2

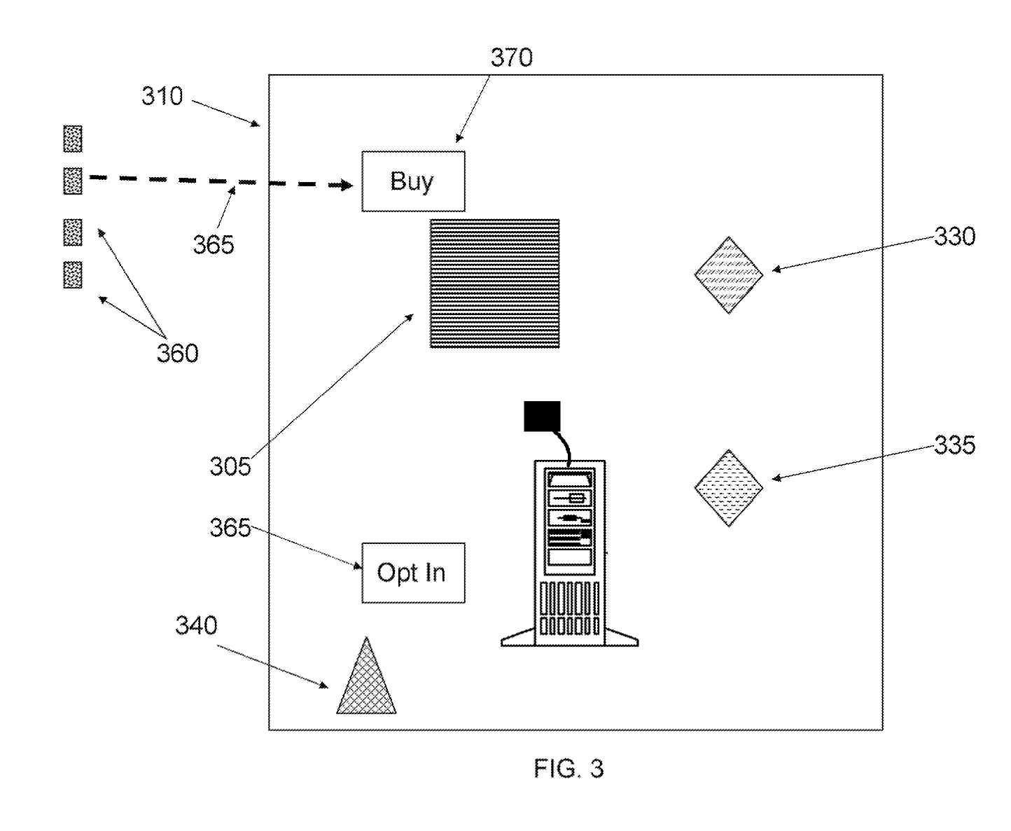

Attention is now directed to FIG. 3, which shows a second embodiment of the present invention. In this embodiment, game theory is used to determine the price of a product 305. A webbased business offers the product 305 for sale. Users 360 who go to the web site 310 can “opt-in” for the sale of the product 305 by actuating an “Opt-in” button 365. By “opting in”, a user identifies himself as a potential buyer of the product 305. The users are generally registered users who may have previously provided some type of identifying information: possibly a password, cell phone number or other information that can be used to uniquely identify a user as well as allow for sending information to the user. A user's opting-in automatically drives down the price of product 305 by a predetermined and generally known amount (not shown). The more people who opt-in on a given product 305, the more the price of the product 305 drops. Individuals interested in buying product 305 would obviously hope that as many people as possible opt-in to the purchase of product 305, as each new user opting in, drives the price down further. The proponent of the sales arrangement may be the merchant. Alternatively, one of the users may initiate the arrangement under pre-approved terms and conditions. While in the previous embodiment, adjustments in price were private and exclusive to the initiator, in this embodiment, price adjustments are available to all participants.

Throughout the sales period (which may be time limited or open ended), the product 305 maintains a dynamic price 335, which reflects the advertised price 330 less an amount that reflects the number of people who have opted in to the purchase of the product 305. The dynamic price 335 could go to zero if enough people opted in and possibly did additional acts (such as view an advertisement 340), an action that also brings down the price of the product 305. Thus, the price of product 305 can vary between the advertised price 330 and zero. This is an important distinction between the present invention and sales as performed by group sales web sites like those of Groupon™. In the latter case, a certain number of people must express interest in buying a product; when that number is reached, the price typically drops in a binary fashion from an original price to a discounted price. In the present invention, each individual who opts into a sale of a product 305 individually reduces the price and may participate in activities that reduce the price 335 by more than the opt-in markdown.

When one of the users 360 decides to purchase the product, he actuates 365 a “Buy” button 370 on the web site 310, which then fixes the price for that purchase at the dynamic price 335 for that moment. Immediately after the purchase, the dynamic price 335 goes up by a fixed and optionally advertised amount, in order to reflect that the dynamic price 335 had reached a point where the product 305 was successfully sold to one of the opted in users. Only opted in users 360 can buy the product 305 at the dynamic price 335. The web site 310 may contact all of those users 360 who opted into the purchase of product 305 so as to alert them that the dynamic price 335 of product 305 has risen. The web site 310 alternatively can alert those who have opted in at any time during the sale of product 305 as to the dynamic price 335 status of the product 305. Such information can be provided by SMS, email, phone application, instant messaging, a dedicated computer window, social network account or by other means.

After the dynamic price 335 of product has gone up due to a first purchase, the dynamic price 335 continues to change. With each purchase of product 305, the price goes up, while new opt-in users and/or additional price-reducing activities such as filling in questionnaires, watching advertisements 340 or other activities causing the web site 310 to reduce the price. Individuals who have opted in can each decide when to purchase product 305, if at all. There is no obligation to buy product and there is no prepayment and generally credit card information is not required to opt-in to a sale.

The embodiment herewith described embodies in some ways game theory as applied to internet shopping. Users join a sale and watch the price of the product decrease as a function of a number of users expressing interest in the product and performing activities, each of which are known to reduce the price of product. At some price level a user or a group of users decide that a purchase is in order. Purchase of product begins to drive the dynamic price 335 back up towards the advertised price 330. Each user may then decide whether to purchase, let the price to continue to rise, or wait for more opt-in users 360 or price-reducing activities to occur. The web site 310 attracts many users 360 through the ability to drive down advertised price 330 and makes up for any lost revenue in the dynamic price 335 of product through advertisements 340 or the like watched by users.

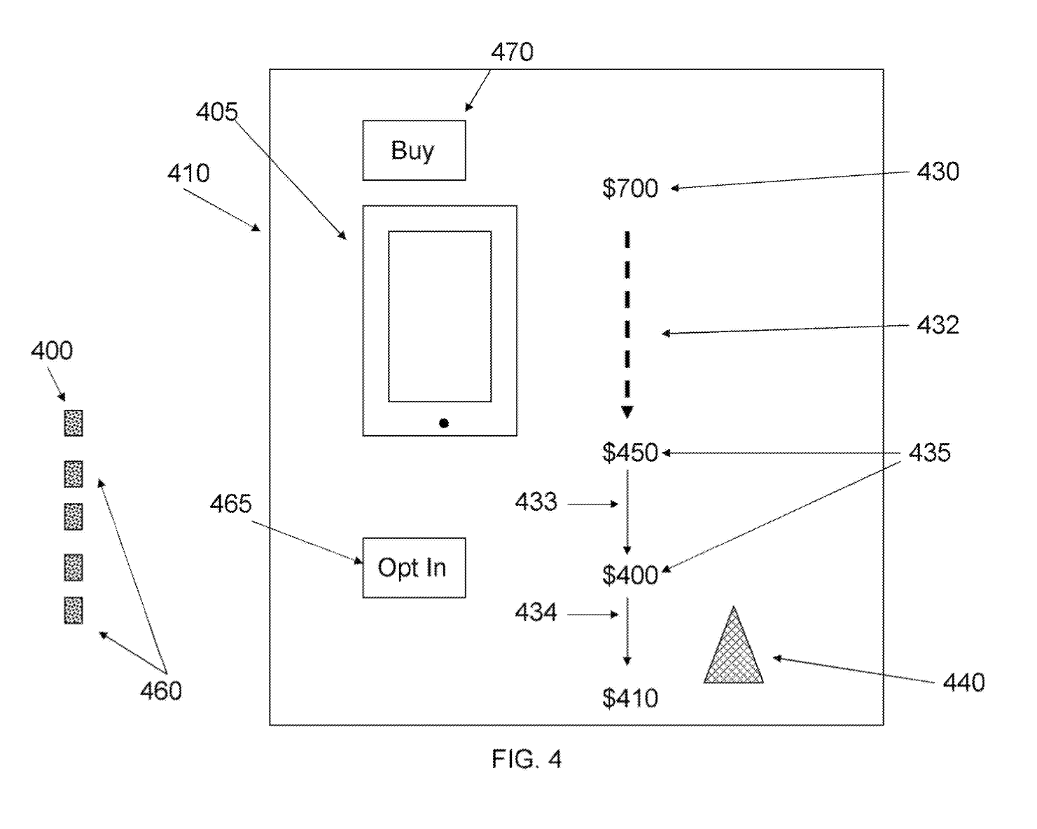

Attention is directed to FIG. 4, which is a diagram illustrating the operation of the embodiment shown in FIG. 3. A web site 410 advertises a tablet computer 405 at unadvertised price 430 ($700). The web site 410 explains that anyone “opting in” to the sale of the tablet computer 405 will cause the price of the tablet computer 405 to drop by 25 cents. Opt-ing in may be performed by actuating an “Opt-in” button 465 on the web site 410. There is no limit to the number of copies of the tablet computer 405 that the web site 410 is able to sell (though they will generally be sold one at a time). One thousand individuals 460, identified by unique cell phone numbers to which a confirmation code is sent by SMS (not shown), opt-in to the sale of the tablet computer 405. The advertised price 430 of the tablet computer is reduced 432 by $250 (1000×$0.25) to a dynamic price 435 of $450. Additionally, 100 of those one thousand individuals 460 who opted in perform an activity. Namely, each fills out a questionnaire 440 related to the quality of products from the manufacturer of the tablet computer 405 (or potentially any other tablet computer). Each filled out questionnaire additionally reduces the price 435 of the tablet computer 405 by 50 cents. Thus, the dynamic price 435 of the tablet computer 405 is further reduced 433 to $400. At this dynamic price, an opted in user 400 actuates the “Buy” button 470 on the web site 410. That user 400 purchases the tablet computer 405 for $400, but the dynamic price 435 jumps 434 $10 to $410. The jump in dynamic price 435 reflects the fact that the tablet computer reached a level ($400) that is attractive for purchase by at least one user 400. After a markup in dynamic price 435 of the tablet computer 405, others may choose to buy the tablet computer 405 rather than risk additional increases in dynamic price 435. They dynamic price when going up may be kept at a new, higher price for a given period of time or may increase with each purchase of the tablet computer 405. With each additional purchase, the dynamic price 435 of the tablet computer rises, while with each additional opt-in or each view of the advertisement 440, the dynamic price 435 of the product drops. This automatic process continues either until a predetermined time or quantity runs out on the product or users stop buying the tablet computer 405.

### Embodiment 3

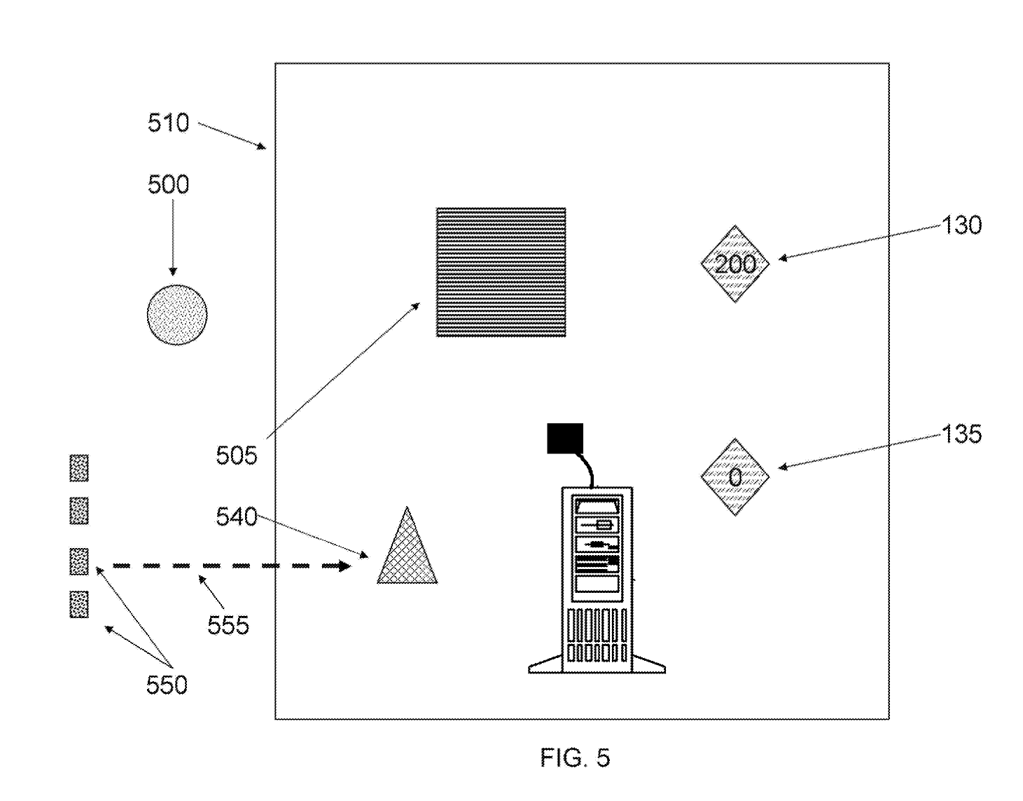

Attention is directed to FIG. 5, which shows a schematic representation of an embodiment of the present invention. A user 500 purchases a product 505 on a web site 510. The web site 510 instructs the user 500 that he can pay for the product 505 after a predetermined period of time; during that time, user 500 can turn to friends, acquaintances, and others 550 that they should watch 555 an advertisement 540 or perform another predetermined activity (not shown), each such viewing or activity causing the web site 510 to reduce the price of the product 505 to be paid by user 500. After the predetermined period of time has elapsed, the web site 510 charges the user 500 according to the advertised price 530 minus any markdowns garnered as a function of activities performed by the friends, acquaintances, and others 550 in support of a price reduction for user 500. In this model, the dynamic price 535 could potentially reach zero if enough activities were performed during the predetermined time period. The web site 510 compensates for the lost payment on product 505 by advertising or other revenues related to the activities performed by user 500 and/or friends, acquaintances, or others 550.

This embodiment is ideal for those who have many “friends” on sites like Facebook and MySpace. After buying product 505, user 500 can turn to his friends and ask for their help in reducing the dynamic price 535 to as low a value as is possible in the time given. Of course, such friends are by no means limited to social network applications.

### Embodiment 4

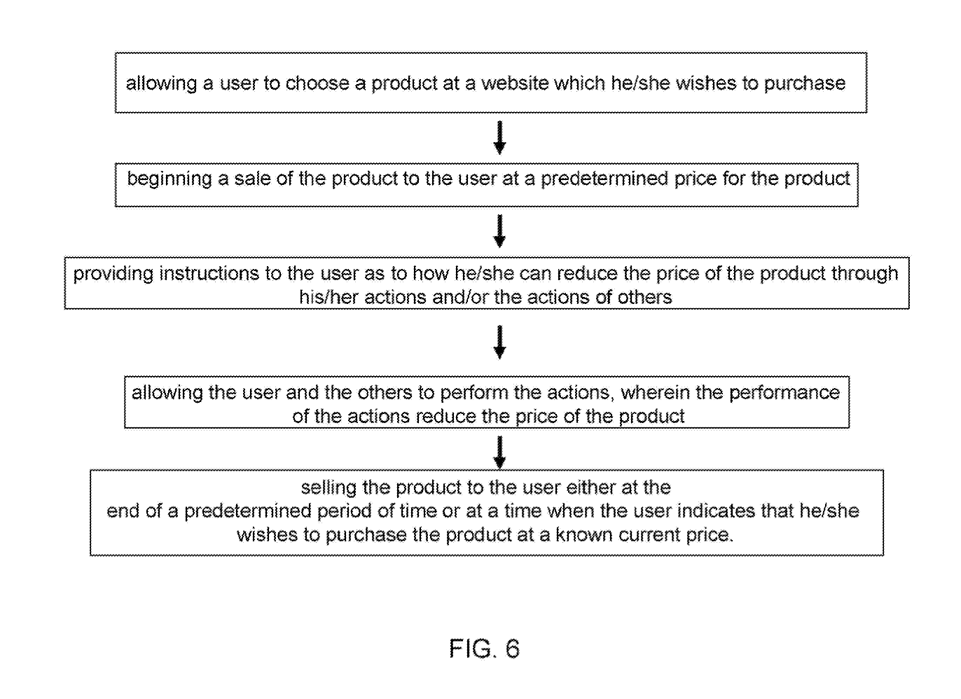

Attention is directed to FIG. 6, which is a flow chart of a method of the present invention. This method is associated with a “private sale” arrangement between a web site and a user or member of the web site. The method includes the following steps: allowing a user to choose a product at a web site, which he wishes to purchase; beginning a sale of the product to the user at a predetermined price for the product; providing instructions to the user as to how he can reduce the price of the product through his/her actions and/or the actions of others; allowing the user and the others to perform the actions, wherein the performance of the actions reduce the price of the product; and, selling the product to the user either at the end of a predetermined period of time or at a time when the user indicates that he wishes to purchase the product at a known current price.

### Embodiment 5

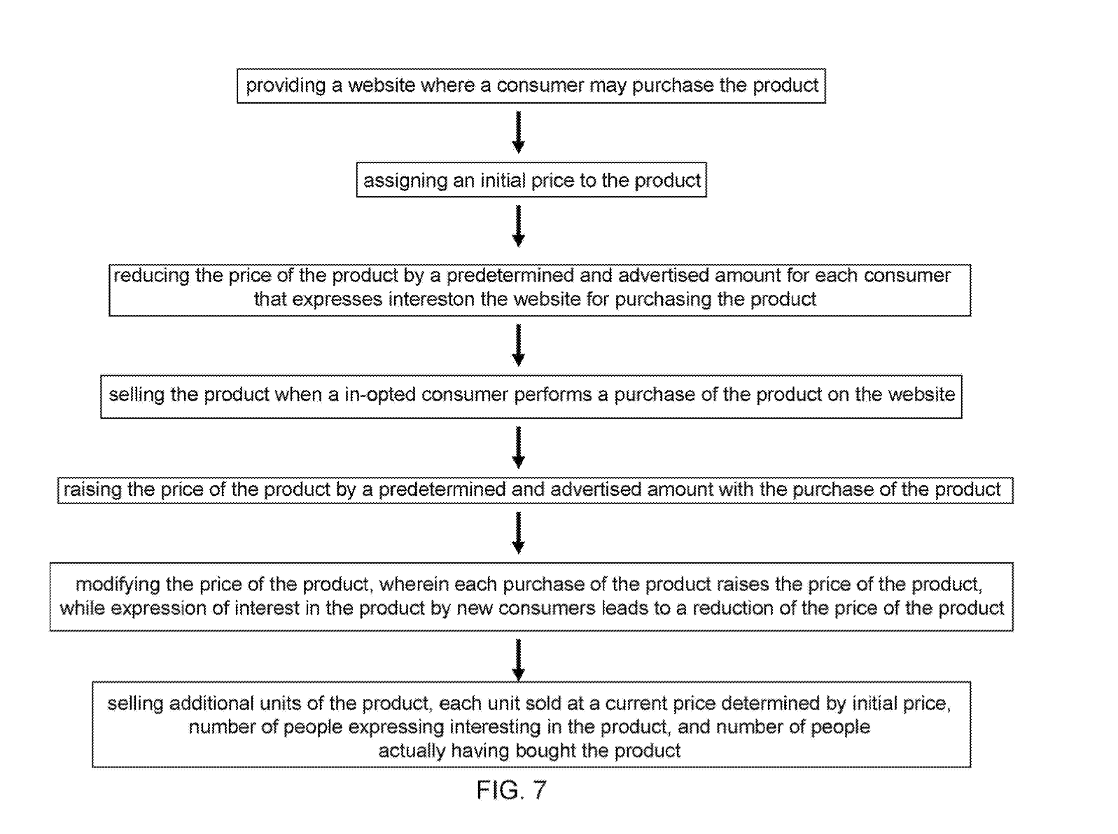

Attention is directed to FIG. 7, which shows a method associated with the instant invention. The method relates to an “opt-in” embodiment for reducing the price of a product. The method includes the following: providing a web site where a consumer may purchase the product; assigning an initial price to the product; reducing the price of the product by a predetermined and advertised amount for each consumer that expresses interest on the web site for purchasing the product; selling the product when a opted-in consumer performs a purchase of the product on the web site; raising the price of the product by a predetermined and advertised amount with the purchase of the product; modifying the price of the product, wherein each purchase of the product raises the price of the product, while expression of interest in the product by new consumers leads to a markdown of the price of the product; and, selling additional units of the product, each unit sold at a current price determined by initial price, number of people expressing interesting in the product, and number of people actually having bought the product.

### Embodiment 6

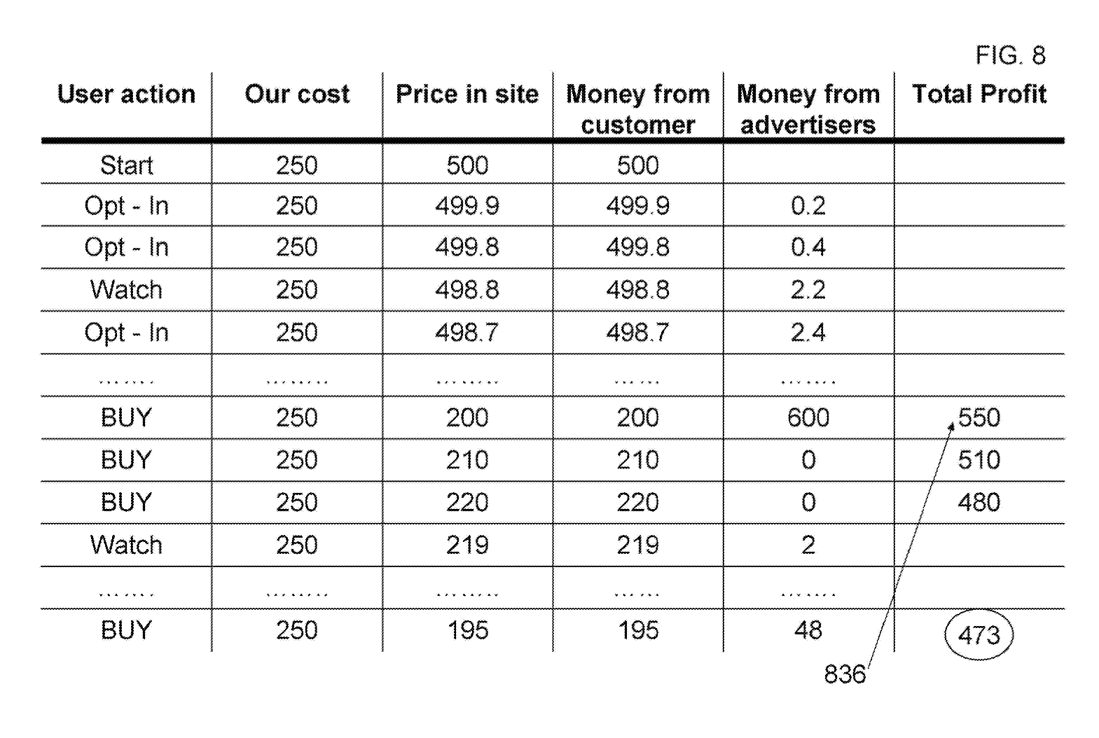

This embodiment is adapted to strategies directed at managing the risk of monetary loss that may be incurred by organization operating the web site. Specifically, the income derived from advertising and related activities that is brought in by reducing the price is greatest per unit with the first sale. FIGS. 8-10 are tables showing examples from the present embodiment in which opt-in reduces the price of product by 10 cents (the web site making 20 cents for each banner advertisement presented when a person executes a “buying”: (a purchase of the product) and potentially $1 for viewing an advertisement (web site making $2/advertisement), while a purchase of the product raises the price $10. These figures are to be read from top to bottom, wherein a series of dots represents intermediate activities not shown for reasons of brevity. As shown in FIG. 8, the greatest profit [symbol] $550 [symbol] occurs 836 with the sale of the first unit at a price of $200. The web site net is $600 in advertising revenue and $200 paid by buyer less $250, the cost of the product for a total of $550 of profit. With the sale of the second unit, net profit drops to $510, which comes to $255 profit per unit. One could stop the sale after a purchase of the first product in order to maximize profit or to establish a lowest allowable price, which may or may not be the purchase price. But then there is a risk that people will stop coming to the site if only one or a very few number of users can buy the product or if there is a defined limit to lower unit price. Instead, additional products are sold at higher prices, but with reduced overall profit. The example in FIG. 8 has sales occurring below the product cost to the web site ($250). As shown in FIG. 8, the final profit for the sale of four units is $473 (shown in circle).

In this embodiment, the server 511 (FIG. 5) includes a monitor program that controls a sale of a product and monitors changes in price as opt-ins, purchases and other actions occur. The program may stop a sale when the net profit per unit reaches a predetermined lower level so as to prevent losses or unacceptable profit levels. Alternatively, the program can stop price reduction at a predetermined price level and/or stop a sale for other reasons that include but are not limited to exhaustion of product inventory. Alternatively, instead of stopping the sale completely, the program can raise the price by more than the $10 and even return the price to a significantly higher level, such as $250 or $350 (base price plus $100 of profit/unit). If the sale is stopped, it may be restarted later at the original price in order to begin the process again.

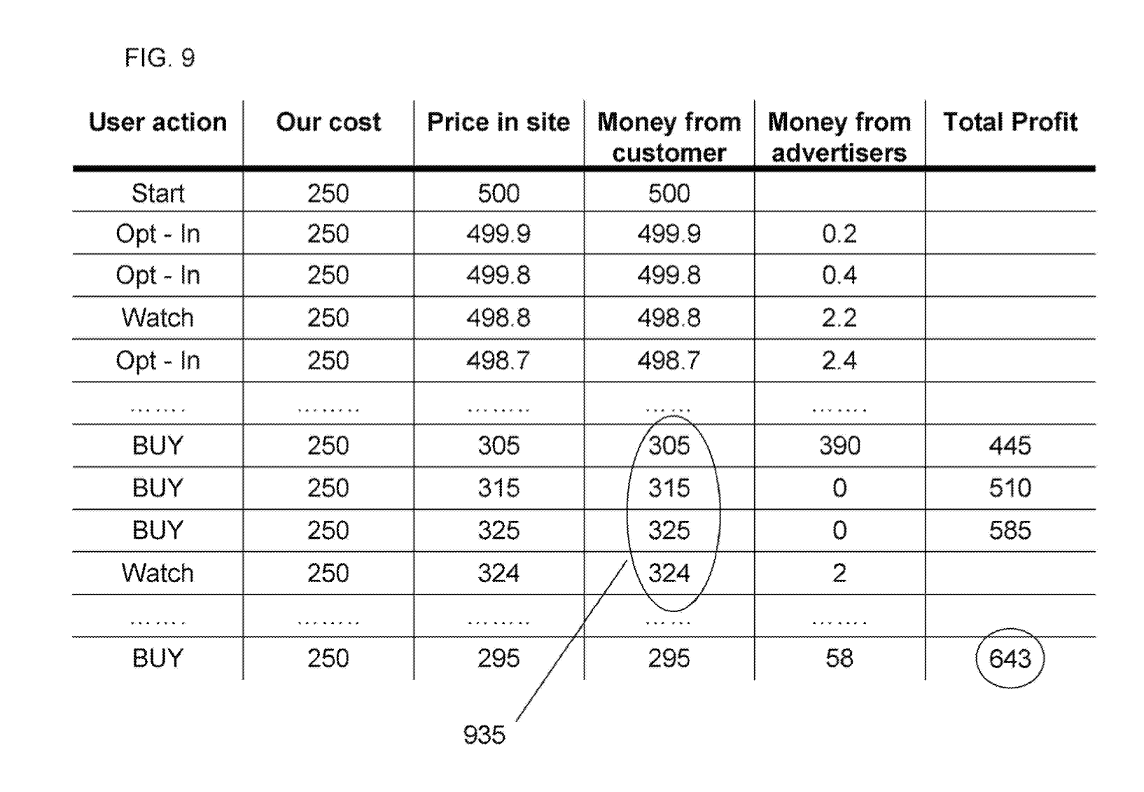

Attention is directed to FIG. 9, where the variable prices (935, shown in ellipse) for sold units are all higher than the $250 unit price paid by the web site for the product. The net profit (shown in circle) of $643 for four units sold yields more than $160 profit per unit, while buyers saved nearly $200 each on the advertised purchase price. In this example, the “Buy” button (not shown) was actuated well above the cost of the product ($250) and subsequent units of product were additionally purchased at profitable prices.

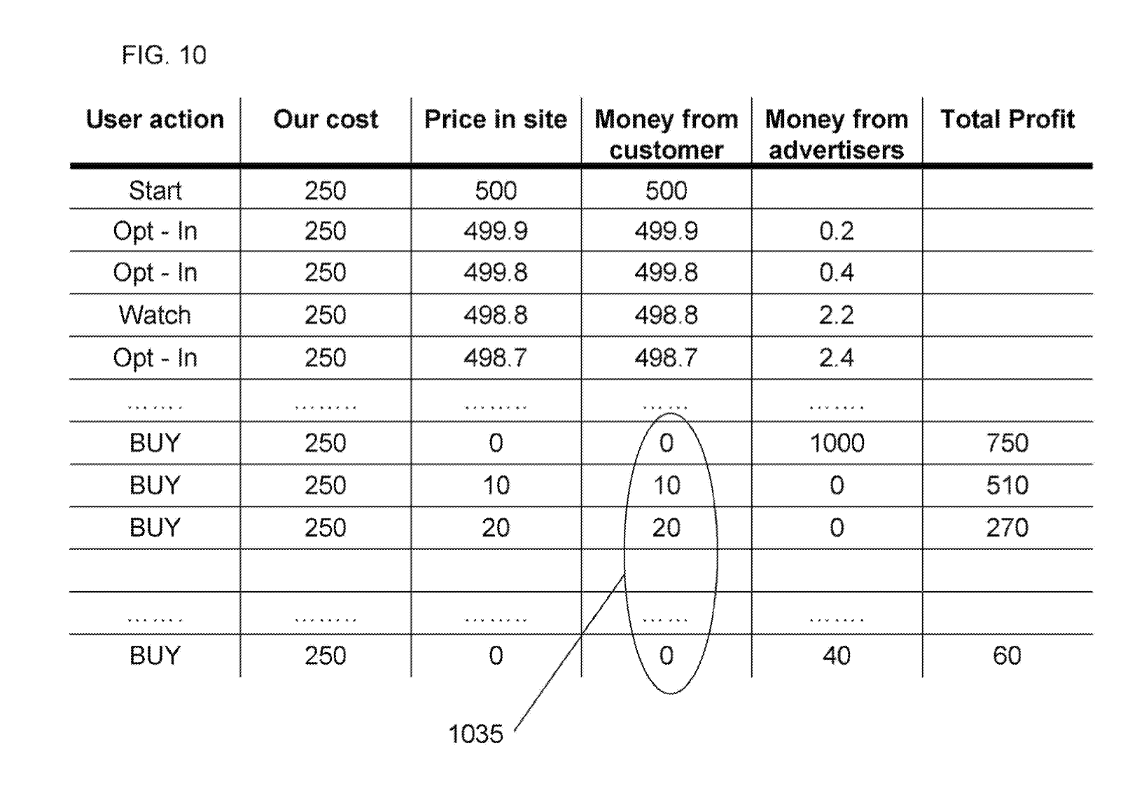

Attention is directed to FIG. 10, which shows an example of the present embodiment of the invention in which the dynamic price 1035 twice reaches zero. Two units are sold at this price and the net profit for sale of four units is $60. While the profit is low, the ability to drive down prices to nothing will allow for a large user base, which means more overall sales as well as higher advertising rates.

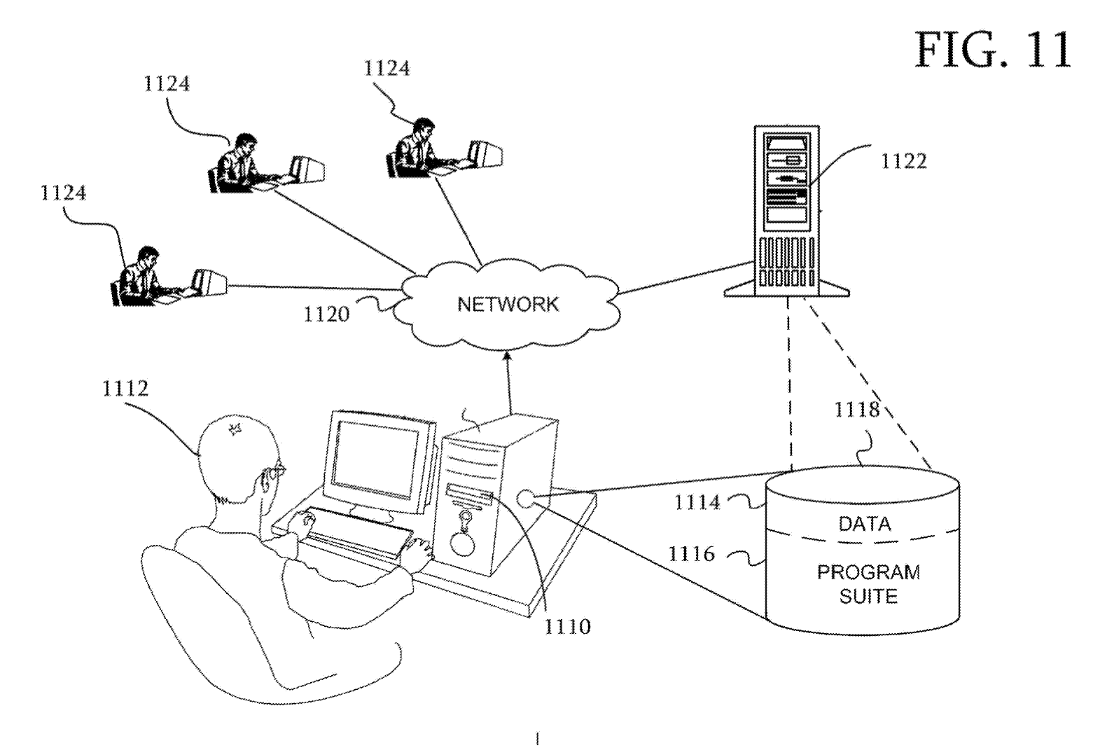

Reference is now made to FIG. 11, which schematically illustrates apparatus that is adapted to executing the methods described in the previous embodiments. A control device, typically a computer 1110, is operated by an administrator 1112. The computer 1110 typically comprises a general purpose or embedded computer processor, which is programmed with suitable software for carrying out the functions described hereinbelow. Thus, although the computer 1110 is described as comprising a number of separate functional blocks, these blocks are not necessarily separate physical entities, but rather may represent different computing tasks or data objects stored in a memory that is accessible to the processor. These tasks may be carried out in software running on a single processor, or on multiple processors. The software may be embodied on any of a variety of known media for use with a computer system, such as a diskette, or hard drive, or CD-ROM. The code may be distributed on such media. Alternatively or additionally, the computer 1110 may comprise a digital signal processor or hardwired logic.

Data 1114 acquired from operation of the above-described sales schemes and a program suite 1116 for carrying out the schemes are stored in memory 1118, which can be any conventional local or distributed memory device or plurality of devices. The computer 1110 is provided with conventional I/O facilities and is connected to a data network 1120, which is typically the Internet. A server 1122, which typically hosts a web site under control of the administrator 1112, is connected to the network 1120. Any number of customers 1124 can access the server 1122. In a social networking context, the customers 1124 may be subscribers of the web site, or may be guest users. In other electronic commerce applications, the customers 1124 may be guest users, or have various privileges and priorities.

The memory 1118 and its contents may be accessible to the computer 1110 or the server 1122 exclusively or nonexclusively. For example, in some embodiments the server 1122 may execute the program suite 1116, autonomously or interactively with the administrator 1112, while in other embodiments the program suite 1116 is controlled directly by the administrator 1112 via the computer 1110, even when the network 1120 is unavailable or disconnected from the computer 1110.

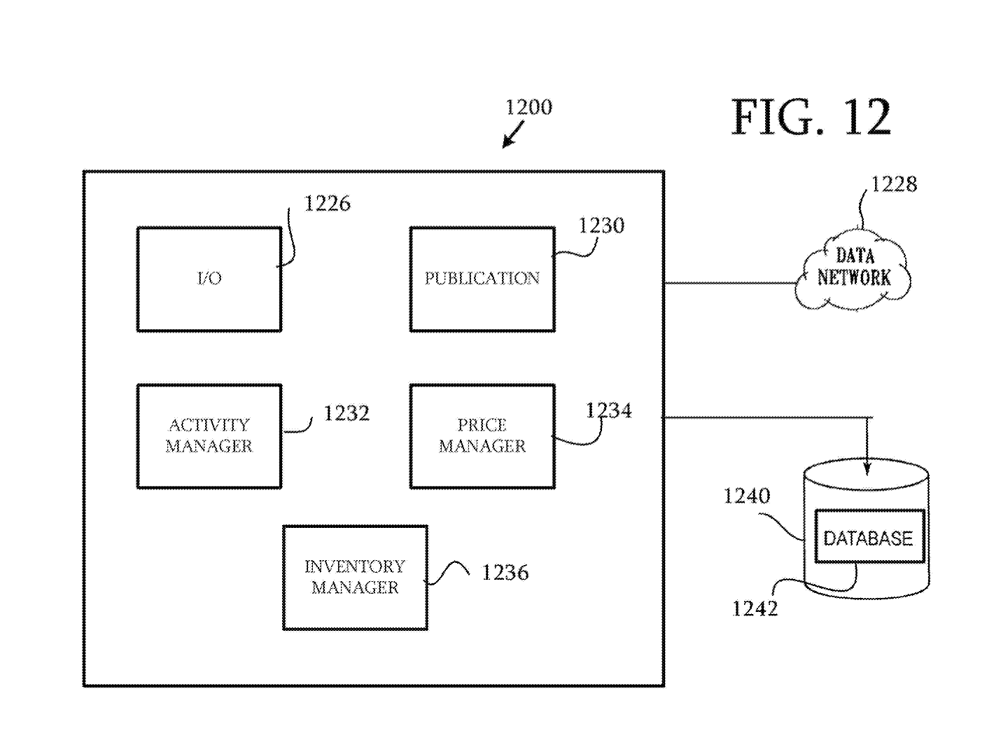

Reference is now made to FIG. 12, which is a block diagram showing aspects of a computing device 1200, which is specially programmed for carrying out the methods described above. An I/O section 1226 mediates communication with other computing devices via a data network 1228. A publication manager 1230 provides sales information, pricing, and information regarding opt-in and related activities via the I/O section 1226. An activity manager 1232 receives opt-in notifications, purchase requests, and other events as specified by the publication manager 1230. A price manager 1234 establishes and dynamically varies pricing of products and services responsively to external administrative directives, i.e., from the administrator 1112 (FIG. 11), or responsively to events recorded by the activity manager 1232. The price manager 1234 may monitor changes in price as opt-ins, purchases and other actions occur. An inventory manager 1236 coordinates with the price manager 1234 and the publication manager 1230 according to inventories of the products and availability of services. Appropriate records of the activity of the various components of the computing device 1200 are maintained in a memory 1240, e.g., in a database 1242.

Embodiments of The present invention may be incorporated in a social network web site or a commercial or retail web site. Users or customers may be ranked according to their activity in purchasing products and/or in participating in activities that reduce product prices. Higher ranked users may receive bigger discounts or may enter a higher category such as “gold”, “silver” or similar categories to rank the web activity of users as it relates to the instant invention. It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A method of electronic commerce, comprising the steps of:
designating an initiator of a sale of an item that is advertised by a merchant at an offering price on an Internet web site, the web site having a plurality of users;
establishing a designation of a set of activities, wherein performance of said activities may lead to the reduction in price of said item;
detecting a performance of one of the activities by at least one of the users;
identifying the at least one of the users as associates of the initiator in the sale;
responsively to the performance making a private offer of the item for sale to the initiator at an adjusted price that is less than the offering price, wherein the offer is capable of acceptance only by the initiator; and
wherein at least one of above steps is performed by a computing device.

2. The method according to claim 1, wherein the set of activities comprises a recruitment of new users to perform the set of activities.

3. The method according to claim 1, wherein said web site is owned by said merchant.

4. The method according to claim 1, wherein the set of activities comprises at least one of the group consisting of, watching specified advertisements, responding to questions, providing requested information, rating products, accessing said web site, accessing at least one other web site, downloading or uploading specified information, and completing a questionnaire.

5. The method according to claim 1, wherein the initiator is exactly one initiator.

6. A computer software product, including a non-transitory computer-readable storage medium in which computer program instructions are stored, which instructions, when executed by a computer, cause the computer to perform the steps of:
designating an initiator of a sale of an item that is advertised by a merchant at an offering price on an Internet web site, the web site having a plurality of users;
establishing a designation of a set of activities, wherein performance of said activities may lead to a reduction in price of said item;
detecting a performance of one of the activities by at least one of the users;
identifying the at least one of the users as associates of the initiator in the sale;
responsively to the performance making a private offer of the item for sale to the initiator at an adjusted price that is less than the offering price, wherein the offer is capable of acceptance only by the initiator; and
wherein at least one of above steps is performed by a computing device.

7. The software product according to claim 6, wherein the set of activities comprises a recruitment of new users to perform the set of activities.

8. The software product according to claim 6, wherein the set of activities comprises at least one of the group consisting of watching specified advertisements, responding to questions, providing requested information, rating products, accessing said web site, accessing at least one other web site, downloading or uploading specified information, and completing a questionnaire.

9. The software product according to claim 6, wherein the initiator is exactly one initiator.

10. A method of electronic commerce, comprising the steps of:
advertising an offer for a sale of a plurality of items by a merchant at a current advertised price on an Internet web site having a plurality of users;
establishing a designation of a set of activities, wherein performance of said activities may lead to the reduction of price of said items;
detecting a performance of one of the activities by the users;
responsively to the performance marking down the current advertised price and advertising a first revised version of the offer on the web site;
detecting a purchase of the one of the items by the users;
responsively to the purchase marking up the current advertised price and advertising a second revised version of the offer on the web site,
wherein at least one of the above steps is performed by a computing device.

11. The method according to claim 10, wherein the set of activities comprises an opt-in activity that expresses an interest in the offer.

12. The method according to claim 10, wherein the set of activities comprises a recruitment of new users to perform the set of activities.

13. The method according to claim 10, wherein the set of activities comprises at least one of the group consisting of purchasing at least one of the items, watching specified advertisements, responding to questions, providing requested information, rating products, accessing said web site, accessing at least one other web site, downloading or uploading specified information, and completing a questionnaire.

14. The method according to claim 10, wherein the set of activities further comprises an opt-in activity that expresses an interest in the offer performed by an opt-in set of the users, respectively, and the purchase further comprises respective purchases of the items by a purchasing set of the users, and wherein marking up and marking down the current advertised price are iteratively performed responsively to the purchases as a function of a number of members of the opt-in set and a number of members of the purchasing set.

15. The method according to claim 10, wherein a current price of said items is passed along to said users by SMS or email.

16. The method according to claim 14, wherein marking down the current advertised price is performed responsively to an addition of a new member to the opt-in set and marking up the current advertised price is performed responsively to an addition of a new member to the purchasing set.

17. The method according to claim 10, wherein establishing a designation of the set of activities comprises providing a set of price-reducing activities to be performed by any of the users and advertising an offer comprises providing a description of the set of price-reducing activities.

18. The method according to claim 10, further comprising the steps of:
detecting an occurrence of a termination condition, the termination condition comprising an adjustment of the current advertised price below a predetermined value; and
withdrawing the offer responsively to detecting the occurrence of the termination condition.

19. A computer software product, including a non-transitory computer-readable storage medium in which computer program instructions are stored, which instructions, when executed by a computer, cause the computer to perform the steps of:
advertising an offer for a sale of a plurality of items by a merchant at a current advertised price on an Internet web site having a plurality of users;
establishing a designation of a set of activities, wherein performance of said activities may lead to the reduction in price of said item;
detecting a performance of one of the activities by the users;
responsively to the performance marking down the current advertised price and advertising a first revised version of the offer on the web site;
detecting a purchase of the one of the items by the users;
responsively to the purchase marking up the current advertised price and advertising a second revised version of the offer on the web site,
wherein at least one of the above steps is performed by a computing device.

20. The software product according to claim 19, wherein the set of activities comprises an opt-in activity that expresses an interest in the offer.

21. The software product according to claim 19, wherein the set of activities further comprises an opt-in activity that expresses an interest in the offer performed by an opt-in set of the users, respectively, and the purchase further comprises respective purchases of the items by a purchasing set of the users, and wherein marking up and marking down the current advertised price are iteratively performed responsively to the purchases as a function of a number of members of the opt-in set and a number of members of the purchasing set.

22. The software product according to claim 21, wherein marking down the current advertised price is performed responsively to an addition of a new member to the opt-in set and marking up the current advertised price is performed responsively to an addition of a new member to the purchasing set.

23. The software product according to claim 19, further comprising the steps of:
detecting an occurrence of a termination condition, the termination condition comprising an adjustment of the current advertised price below a predetermined value; and
withdrawing the offer responsively to detecting the occurrence of the termination condition.
